(19) United States
(12) Patent Application Publication
(10) Pub. No.: US 2002/0151097 A1
(43) Pub. Date: Oct. 17, 2002

(54) Flat panel display and method for forming the same

(75) Inventor: Jia-Fam Wong, Hsinchu (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU Optronics Corp.

(21) Appl. No.: 10/081,338

(22) Filed: Feb. 22, 2002

(30) Foreign Application Priority Data
Mar. 30, 2001 (TW) 90107642

(51) Int. Cl. G02F 1/136

(52) U.S. Cl. 438/48

(57) ABSTRACT

A panel of a flat panel display comprises a glass substrate, switches, photoresist layers, signal lines disposed on the glass substrate along a first direction, and gate lines disposed on the glass substrate along a second direction and across the first direction to define pixels. Each pixel includes a first area. A plurality of switching units are formed in the first areas of the pixels to control the corresponding pixels. The first, second, and third photoresist layers are disposed in the first, second, and third groups of the pixels, the each first area of each pixel is covered by at least two of the first, second, and third photoresist layers.

### BACKGROUND OF THE INVENTION

1. Field of the Invention

The present invention relates in general to a flat panel display and method for forming the same. In particular, the present invention relates to a flat panel display structure in which a color filter and thin film transistors (TFTs) are disposed on the same substrate, and to methods for forming the same.

2. Description of the Related Art

Liquid Crystal Displays (LCDs) are widely utilized in the personal computers, navigation systems, projectors, viewfinders and portable machines (such as watches, electronic calculators, and televisions) because of its low power consumption, thin profile, light weight, and low driving voltage.

The color filter is the key component of a color LCD. Typically, the color filter and the thin-film transistors (TFTs), which act as driving switches, are disposed on two separate substrates and are located on the opposite side of the liquid crystal layer. Above the thin film transistors the black matrix is formed on the color filter's substrate to block off the light from damaging the TFTs. However, it induces higher cost and longer fabrication processing time; in addition, a lot of manufacturing processes are needed.

### SUMMARY OF THE INVENTION

Therefore, an object of the present invention is to provide a structure in which the color filter and the black matrix are formed on the TFT array substrate, and method for forming the same. Thus simplifies the manufacturing process, shortens the operation time and reduces the fabricating cost.

To achieve the above-mentioned object, a panel of a flat panel display is provided. The panel of the flat panel display includes a glass substrate, a plurality of signal lines disposed on the glass substrate along a first direction, and a plurality of gate lines disposed on the glass substrate along a second direction to define a plurality of pixels. The first direction is perpendicular to the second direction, and each pixel includes a first area. The panel also includes a plurality of switching units disposed in the first areas of the pixels, a first photoresist layer covering a first group of the pixels, a second photoresist layer covering a second group of the pixels, and a third photoresist layer covering a third group of the pixels. The first area of each pixel is covered by at least two of the first, second and third photoresist layers.

The switching units are thin film transistors, and, in each first area, the panel further includes a plurality of through holes in at least two of the first, second and third photoresist layers so as to expose each drain electrode of each thin film transistor therein.

The panel further comprises a conducting layer formed on the first, second and third photoresist layers and connected to each drain electrode via each corresponding through hole in the first area.

The panel further comprises a passivation layer formed between the first photoresist layer and each switching unit in each first area, and a conducting layer on the first, second and third photoresist layers. The switching units are thin film transistors, and a plurality of through holes are formed in at least two of the first, second and third photoresist layers and the passivation layer so as to expose drain electrodes of the thin film transistors. The conducting layer is connected to each drain electrode via each through hole in each first area.

The panel of the flat panel display is a TFT array panel.

The TFT array panel can be formed by the following steps. First, forming on the substrate a plurality of signal lines along a first direction and a plurality of gate lines along a second direction to define a plurality of pixels, the first direction is perpendicular to the second direction, and each pixel including a first area. Then, forming a switching unit in the first area of each pixel, forming a first photoresist layer to cover a first group of the pixels, forming a second photoresist layer to cover a second group of the pixels, and forming a third photoresist layer to cover a third group of the pixels. The first area of each pixel is covered by at least two of the first, second and third photoresist layers.

The method also includes a step of forming a through hole in at least two of the first, second and third photoresist layers within each first area so as to expose each drain electrode of each thin film transistor. The method also includes a step of forming a conducting layer on the first, second and third photoresist layers. The conducting layer connects to each drain electrode of each thin film transistor via its corresponding through hole. The method further comprises a step of forming a passivation layer between the first photoresist layer and the switching units, and a plurality of through holes are formed in at least two of the first, second, and third photoresist layers and the passivation layer so as to expose drain electrodes of the thin film transistors therein.

### BRIEF DESCRIPTION OF THE DRAWINGS

The present invention will become more fully understood from the detailed description given herein and the accompanying drawings, given by way of illustration only and thus not intended to be limitative of the present invention.

FIGS. 1A˜1F show cross-sections of a TFT array panel according to an embodiment of the present invention.

FIG. 2 shows a cross-section of a TFT array panel according to another embodiment of the present invention.

FIG. 3 shows a cross-section of a LCD with a TFT array panel according to another embodiment of the present invention.

FIG. 4 shows a cross-section of a TFT array panel according to the embodiment of the present invention.

FIG. 5 shows a cross-section of an IPS mode LCD with a TFT array panel according to the embodiment of the present invention.

### DETAILED DESCRIPTION OF THE PREFERRED EMBODIMENT

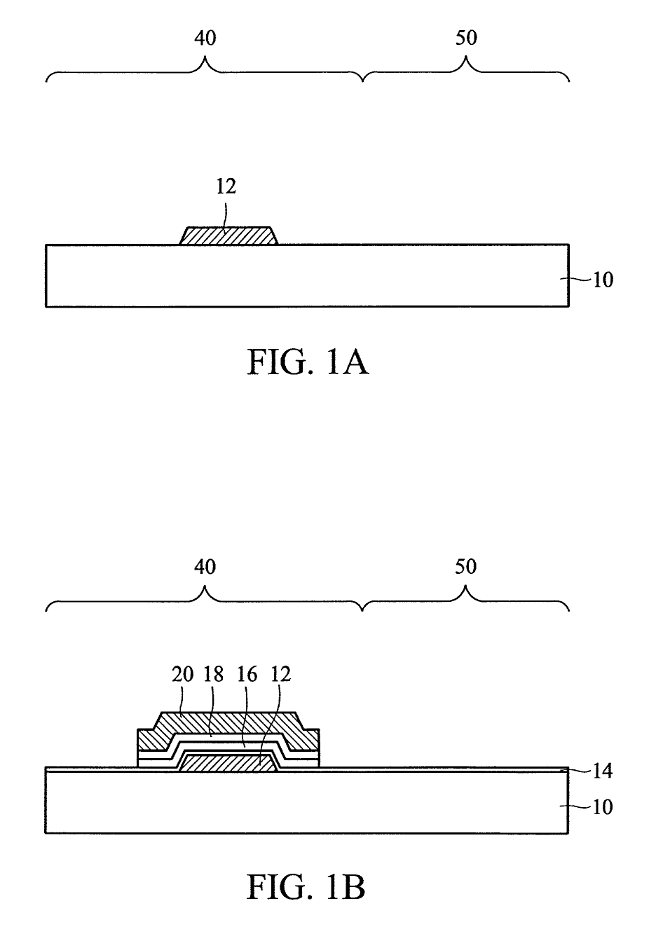

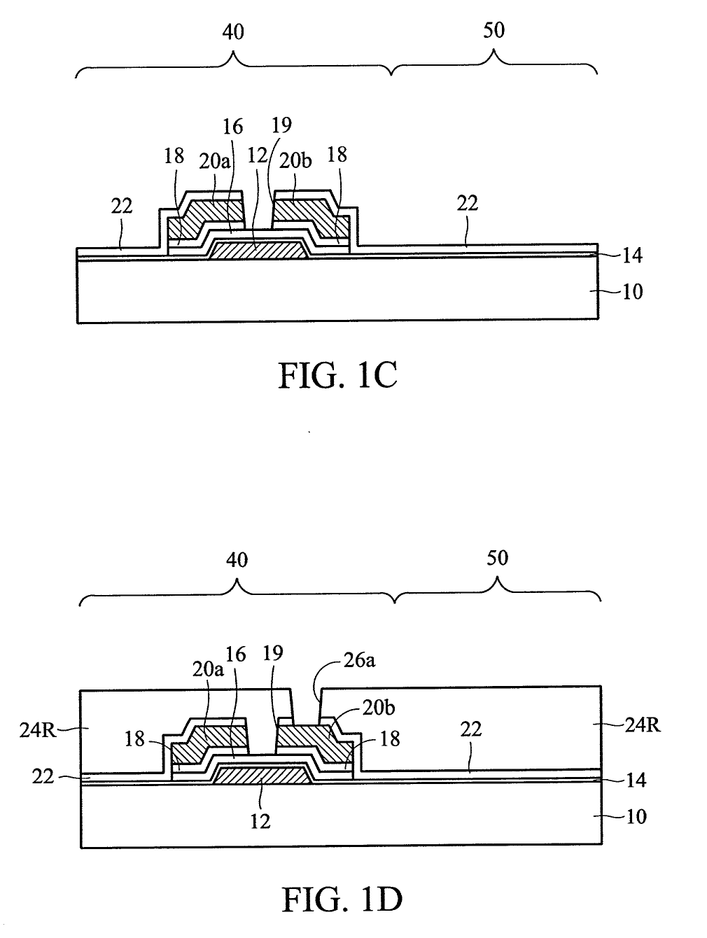

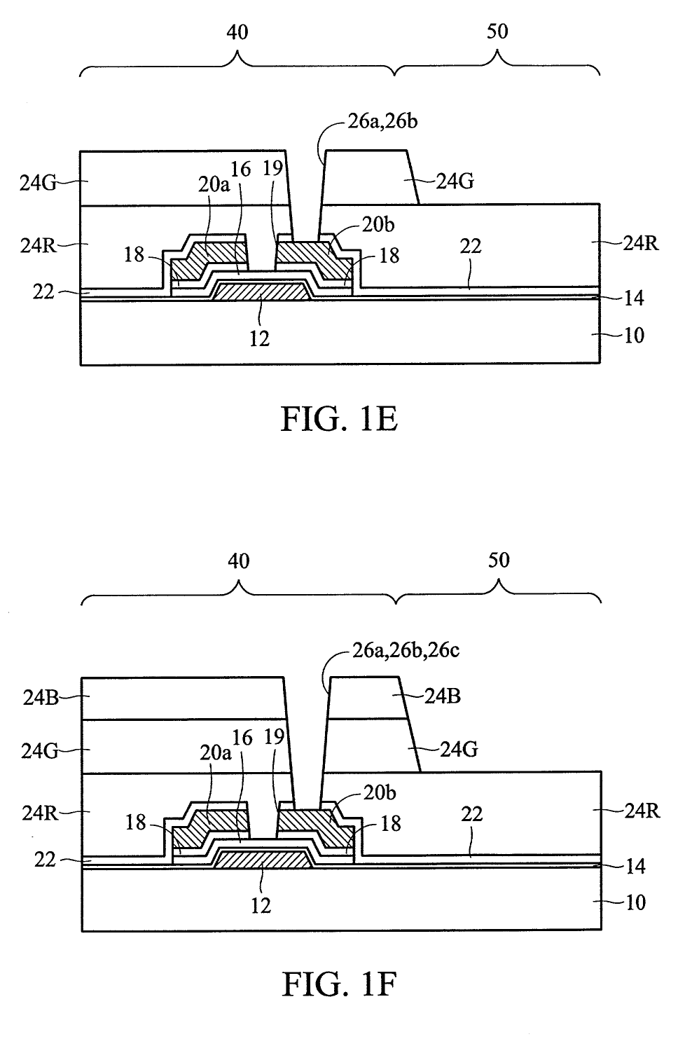

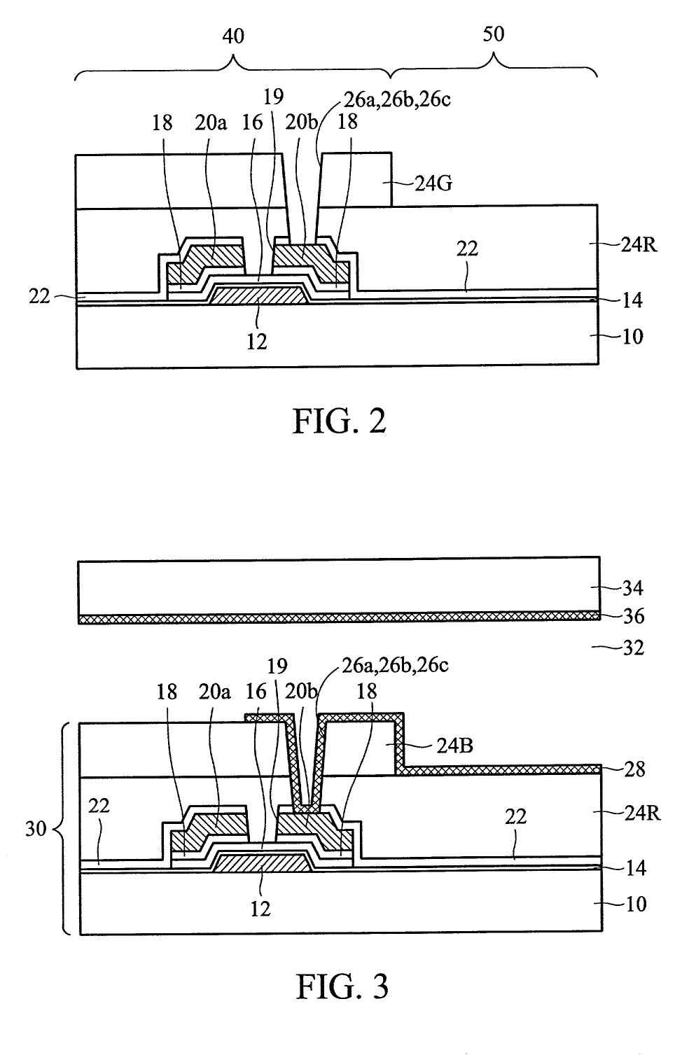

A detailed description of the formation of a TFT array panel according to the present invention is given here with reference to FIGS. 1A˜1F. The TFT array panel includes a plurality of pixels and first areas. The first area can be a black area. In FIG. 1F, FIG. 2 and FIG. 3, take a pixel (such as a red pixel) 50 and a black area 40 for an example. A TFT is disposed in the black area 40. The TFT dominates the corresponding pixel 50.

In FIG. 1A, a glass substrate 10 is provided. The gate lines 12 are formed on the glass substrate 10 by the first photolithography and etching processes.

Referring to FIG. 1B, an insulating layer 14 is formed on the gate lines 12 and the glass substrate 10. The insulating layer 14 can be made of silicon oxide. An amorphous silicon layer 16, an n-doped silicon layer 18 and a metal layer 20 are sequentially formed on the insulating layer 14. The second photolithography and etching processes are used to pattern the amorphous silicon layer 16, the n-doped silicon layer 18 and the metal layer 20. A signal line (not shown) is also formed by the metal layer 20 in a specific area. On the glass substrate 10, the gate lines are disposed along a first direction, the signal lines are disposed alone a second direction, and the first direction is perpendicular to the second direction so as to define these pixels.

In FIG. 1C, a passivation layer 22 covers the metal layer 20, n-doped silicon layer 18, amorphous silicon layer 16 and insulating layer 14. The third photolithography and etching processes are used to define a channel 19 in the passivation layer 22, metal layer 20 and n-doped silicon layer 18. The amorphous silicon layer 16 is exposed in the channel 19, a source electrode 20a and a drain electrode 20b are then defined. The passivation layer 22 can be made of silicon nitride.

Referring to FIG. 1D, a first color photoresist layer, such as a red photoresist layer 24R, is formed. The through hole 26a is formed in the red photoresist layer 24R and the passivation layer 22 so as to expose the drain electrode 20b in the through hole 26a. The red photoresist layer 24R covers the red pixel 50 and also covers a part or all of the black area 40.

As shown in FIG. 1E, a second color photoresist layer, such as a green photoresist layer 24G, is formed. The through hole 26b is formed in the green photoresist layer 24G so as to expose the drain electrode 20b. The green photoresist layer 24G covers the green pixel and also covers a part or all of the black area 40.

As shown in FIG. 1F, a third color photoresist layer, such as a blue photoresist layer 24B, is formed. The through hole 26c is formed in the blue photoresist layer 24B so as to expose the drain electrode 20b. The blue photoresist layer 24B covers the blue pixel and also covers a part or all of the black area 40.

The passivation layer 22 can be omitted, and the color photoresist layers are then used to protect the TFT. In this situation, the chemical vapor deposition (CVD) process used to deposit the passivation layer 22 can be eliminated.

The sequence of forming the red photoresist layer 24R, green photoresist layer 24G, and blue photoresist layer 24B is not limited and can be altered randomly.

By using the above-mentioned process, the black area 40 in the TFT array panel 30 is covered with three kinds of color layers (24R, 24G and 24B). Therefore, they can shield off light and be used as the black matrix. Only two kinds of color layers (such as 24R/24G, 24R/24B or 24G/24B) can also function as the black matrix to cover the black area 40, as shown in FIGS. 2 and 3.

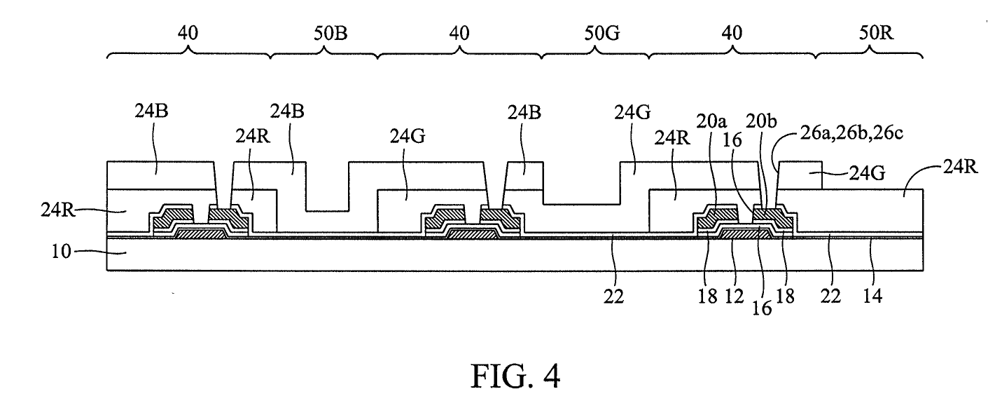

FIG. 4 shows the TFT array panel 30 with red, green and blue pixels. The black area 40 includes any two kinds of color photoresist layers, such as the red and blue photoresist layers 24R and 24B, the green and blue photoresist layers 24G and 24B, or the red and green photoresist layers 24R and 24G in different pixel. In this figure, 50R, 50G and 50B indicate the red pixel, green pixel and blue pixel respectively.

A conducting layer can be further formed above the red, green and blue photoresist layers 24R, 24G and 24B to form the pixel electrodes 28 in each pixel, as shown in FIG. 3. The pixel electrodes 28 can be made of indium tin oxide (ITO). Each pixel electrode 28 connects the corresponding drain electrode 20b via the through holes 26a, 26b and 26c.

A second panel 34 is provided as shown in FIG. 3. A counter electrode 36 and an alignment film (not shown) are formed on the second panel 34. A liquid crystal layer 32 is then disposed between the second panel 34 and the TFT array panel 30 to constitute a LCD.

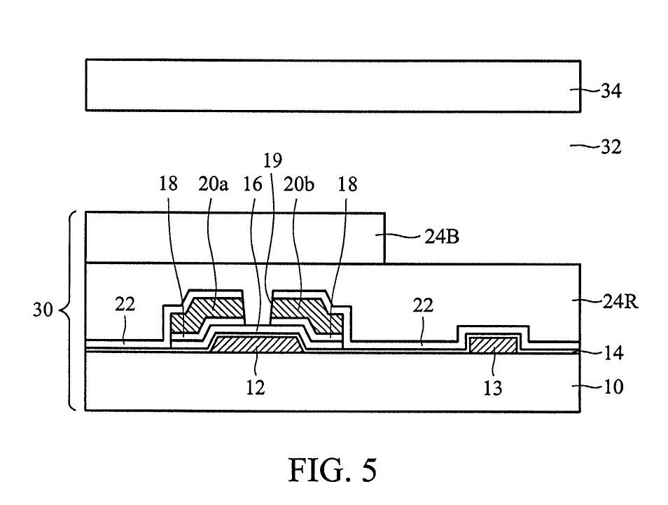

The above-mentioned method can also be used to form an in-plane switch (IPS) mode LCD or other LCDs without pixel electrodes. FIG. 5 shows a cross-section view of the IPS LCD by using a TFT array panel according to the present invention. The counter electrode 13 is formed on the TFT array panel 30, and the pixel electrodes are not necessary. Therefore, the processes for forming the through holes 26a, 26b and 26c are eliminated. In FIG. 5, the passivation layer 22 can also be omitted.

According to the above-mentioned description, the present invention has at least the following advantages and characteristics. First, the color filter and the thin film transistors (TFTs) are formed on the same panel so as to simplify the process. Second, the black matrix is formed by the color filter. The black matrix can be constituted by two or three kinds of color photoresist layers. The color filter formed above the TFTs can be used to protect the TFTs.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for forming a transistor array on a substrate, comprising the steps of:
forming on the substrate a plurality of signal lines along a first direction and a plurality of gate lines along a second direction to define a plurality of pixels, the first direction being perpendicular to the second direction, each pixel including a first area;
forming a switching unit in the first area of each pixel;
forming a first photoresist layer to cover a first group of the pixels;
forming a second photoresist layer to cover a second group of the pixels; and
forming a third photoresist layer to cover a third group of the pixels,
wherein the first area of each pixel is covered by at least two of the first, second and third photoresist layers.

2. The method of claim 1 wherein the switching units are thin film transistors, and the method further comprises a step of forming a through hole in at least two of the first, second and third photoresist layers within each first area so as to expose each drain electrode of each thin film transistor.

3. The method of claim 2, further comprising a step of forming a conducting layer on the first, second and third photoresist layers, wherein the conducting layer connects to each drain electrode of each thin film transistor via its corresponding through hole.

4. The method of claim 1, further comprising a step of forming a passivation layer between the first photoresist layer and the switching units.

5. The method of claim 4 in which the switching units are thin film transistors, further comprising a step of forming a plurality of through holes in at least two of the first, second, and third photoresist layers and the passivation layer so as to expose drain electrodes of the thin film transistors therein.

6. The method of claim 5, further comprising a step of forming a conducting layer on the first, second and third photoresist layers, and the conducting layer being connected to each drain electrode via each corresponding through hole in the first area.

7. A panel of a flat panel display, comprising:
a glass substrate;
a plurality of signal lines disposed on the glass substrate along a first direction and a plurality of gate lines disposed on the glass substrate along a second direction to define a plurality of pixels, the first direction being perpendicular to the second direction, each pixel including a first area;
a plurality of switching units disposed in the first areas of the pixels;
a first photoresist layer covering a first group of the pixels;
a second photoresist layer covering a second group of the pixels; and
a third photoresist layer covering a third group of the pixels,
wherein the first area of each pixel is covered by at least two of the first, second and third photoresist layers.

8. The panel of claim 7 wherein the switching units are thin film transistors, and, in each first area, the panel further comprises a plurality of through holes in at least two of the first, second and third photoresist layers so as to expose each drain electrode of each thin film transistor therein.

9. The panel of claim 8, further comprising a conducting layer formed on the first, second and third photoresist layers and connected to each drain electrode via each corresponding through hole in the first area.

10. The panel of claim 7, further comprising a passivation layer formed between the first photoresist layer and each switching unit in each first area.

11. The panel of claim 10 wherein the switching units are thin film transistors, and the substrate further comprises a plurality of through holes in at least two of the first, second and third photoresist layers and the passivation layer so as to expose drain electrodes of the thin film transistors.

12. The panel of claim 11, further comprising a conducting layer formed on the first, second and third photoresist layers, and connected to each drain electrode via each through hole in each first area.

13. A flat panel display, comprising:
a first substrate;
a second substrate facing the first substrate;
a liquid crystal layer disposed between the first substrate and the second substrate;
a plurality of signal lines disposed on the first substrate along a first direction and a plurality of gate lines disposed on the glass substrate along a second direction to define a plurality of pixels, the first direction being perpendicular to the second direction, each pixel having a first area;
a plurality of switching units disposed in the first areas of the pixels;
a first photoresist layer covering a first group of the pixels;
a second photoresist layer covering a second group of the pixels; and
a third photoresist layer covering a third group of the pixels,
wherein the first areas of each pixel is covered by at least two of the first, second and third photoresist layers.

14. The display of claim 13 wherein the switching units are thin film transistors, and the display further comprises a plurality of through holes formed in at least two of the first, second and third photoresist layers so as to expose drain electrodes of the thin film transistors therein.

15. The display of claim 14, further comprising a conducting layer formed on the first, second and third photoresist layers and connected to each drain electrode via its corresponding through hole in the first areas.

16. The display of claim 13, further comprising a passivation layer formed between the first photoresist layer and the switching units.

17. The display of claim 16 wherein the switching units are thin film transistors, and the display further comprises a plurality of through holes formed in at least two of the first, second and third photoresist layers and the passivation layer so as to expose drain electrodes of the thin film transistors therein.

18. The display of claim 17, further comprising a conducting layer formed on the first, second and third photoresist layers and connected to each drain electrode via its corresponding through hole.
